(19) United States
(12) Patent Application Publication
(10) Pub. No.: US 2024/0361493 A1
(43) Pub. Date: Oct. 31, 2024

(54) METHOD FOR PREDICTING THE TIME EVOLUTION OF A PARAMETER FOR A SET OF WELLS

(71) Applicant: TotalEnergies One Tech, COURBEVOIE (FR)

(72) Inventors: Achraf OURIR, NEUILLY-SUR-SEINE (FR); Baptiste RONDELEUX, PARIS (FR); Zinyat AGHAZAYEVA, PARIS (FR); Raquel MOUSSA, BOULOGNE-BILLANCOURT (FR); Daniel BUSBY, PAU (FR); Jed OUKMAL, PAU (FR)

(73) Assignee: TotalEnergies One Tech, COURBEVOIE (FR)

(21) Appl. No.: 18/577,151

(22) PCT Filed: Jul. 8, 2021
(86) PCT No.: PCT/IB2021/000459

§ 371 Date: Jan. 5, 2024

(51) Int. Cl. G01V 20/00; E21B 47/003

(52) U.S. Cl. CPC G01V 20/00; E21B 47/003; E21B 2200/20

(57) ABSTRACT

The present invention concerns a method for predicting the time evolution of a parameter for a set of wells, the method comprising selecting one or more prediction algorithms from a catalog, building, for each well, a prediction model on the basis of the selected algorithm(s) and of input data relative to each well of the set, the prediction model of each well being built with the first prediction algorithm for which a conformity criterion is fulfilled considering an order of use of the selected algorithms, validating the prediction models built for each well, and prediction of the time evolution of the at least one parameter for a well on the basis of the validated prediction model obtained for said well and on the input data of said well.

### CROSS REFERENCE TO RELATED APPLICATION

The present application is a U.S. National Phase Application under 35 U.S.C. § 371 of International Patent Application No. PCT/IB2021/000459 filed Jul. 8, 2021. The entire contents of which are hereby incorporated by reference.

### TECHNICAL FIELD OF THE INVENTION

The present invention concerns a method for predicting the time evolution of at least one parameter for a set of wells. The present invention also relates to an associated computer program product.

### BACKGROUND OF THE INVENTION

In the field of forecasting hydrocarbon field production, two major approaches are generally used.

The first methodology relies on dynamic flow simulations, which allow a complete modelling of the subsurface physics and development plan. Dynamic simulation methods are often used for undeveloped fields (“green fields”) or for major redevelopments. They require an extensive amount of data to build accurate models, and they are time and man-power consuming (around 6 months to 1 year for a first version).

The second methodology relies on analytical methods and is used for fields already in production. Classical analytical methods are mainly based on the Arps equations, and their derivatives. In recent years, some methods using regression (ensemble methods) have also been developed.

Despite analytical methods being much simpler, and mostly used for mature (or declining) fields, often with a large number of wells, their application often relies on heavy manual input, and engineer know-how to distinguish and adapt to the variety of well behaviors in a field (declining and non-declining wells). In addition, these methods are subjective methods whose results may vary from one engineer to another.

Therefore, there exists a need for a method enabling to predict the behavior of a wide range of wells in a more efficient and replicable way.

### SUMMARY OF THE INVENTION

To this end, the present description relates to a method for predicting the time evolution of at least one parameter for a set of wells, the method comprising the following steps which are implemented by a computer:
obtaining input data relative to each well of the set, the input data of at least some wells, called existing wells, comprising a past evolution of the at least one parameter for said wells,
selecting one or more prediction algorithms from a catalog comprising a plurality of prediction algorithms, each prediction algorithm being associated with a conformity criterion, when several prediction algorithms are selected, each algorithm being affected with an order of use,
building, for each well, a prediction model predicting the evolution of the at least one parameter for said well on the basis of the selected algorithm(s) and of the input data, the prediction model of each well being built with the first prediction algorithm for which the conformity criterion is fulfilled considering the order of use of the selected algorithms,
validating the prediction models built for each well, and
prediction of the time evolution of the at least one parameter for at least one well on the basis of the validated prediction model obtained for said well and on the input data of said well.

The method according to the present description may comprise one or more of the following features considered alone or in any combination that is technically possible:
the validation step comprises predicting, for each well of a subset of wells among the existing wells, the evolution on a past time period of the at least one parameter, on the basis of the prediction model obtained for said well and of only some input data relative to said well by excluding the other input data relative to said well, the excluded data being the past evolution of the at least one parameter on the past time period, and comparing the predicted evolution of the at least one parameter with the excluded input data on the basis of a consistency criterion, the prediction model of said wells being validated when the consistency criterion is fulfilled;
the validation step comprises predicting, for each well of a subset of wells among the existing wells, the evolution on a past time period of the at least one parameter, on the basis of the prediction model obtained for said well and of only some input data relative to said well by excluding the other input data relative to said well, the excluded data being the past evolution of the at least one parameter on the past time period, the prediction models of the wells being validated when a blind test criterion is fulfilled, the blind test criterion stating that the prediction algorithm of each well is validated when a number of validated prediction models for the whole set of wells is above a predetermined threshold, the prediction model of each well being validated when a consistency criterion is fulfilled for said well;
the consistency criterion is validated when the deviation between, the predicted cumulated values of the at least one parameter over the past time period and the cumulated values of the at least one parameter over the same past time period obtained with the input data, is inferior to a predetermined deviation;
the catalog comprises at least two types of algorithms: one first type based on analytical equations and one second type based on machine learning, preferably at least one algorithm of each type being selected during the selection step;
the input data also comprises, for each well, data relative to the intrinsic properties of said well, such as field data, reservoir information, well location data petrochemical data or well length;
the set of wells comprises both existing wells and new wells, new wells being wells for which there is no available past data relative to the at least one parameter;
the considered past time period for the validation step is the entire period of the input data corresponding to the past evolution of the at least one parameter, which enables the validation or not of the prediction models of both existing wells and new wells;
the method comprises a step of operating at least one well of the set of wells depending on the prediction obtained for said well;
the at least one parameter comprises at least one of the following parameters: the production of oil, the production of gas and the production of water;
the method is carried out for a first parameter among: the production of oil, the production of gas and the production of water, and is then carried out for at least another different parameter among: the production of oil, the production of gas and the production of water;
the prediction obtained for the at least another parameter depends on the prediction obtained for the first parameter.

The present description also relates to a computer program product comprising a readable information carrier having stored thereon a computer program comprising program instructions, the computer program being loadable onto a data processing unit and causing a method as previously described to be carried out when the computer program is carried out on the data processing unit.

The present description also relates to a readable information carrier on which a computer program product as previously described is stored.

### BRIEF DESCRIPTION OF THE DRAWINGS

The invention will be easier to understand in view of the following description, provided solely as an example and with reference to the appended drawings in which:

FIG. 1 is a schematic view of an example of a calculator allowing the implementation of a method for predicting the time evolution of at least one parameter for a set of wells, and

FIG. 2 is a flowchart of an example of implementation of a method for predicting the time evolution of at least one parameter for a set of wells.

### DETAILED DESCRIPTION

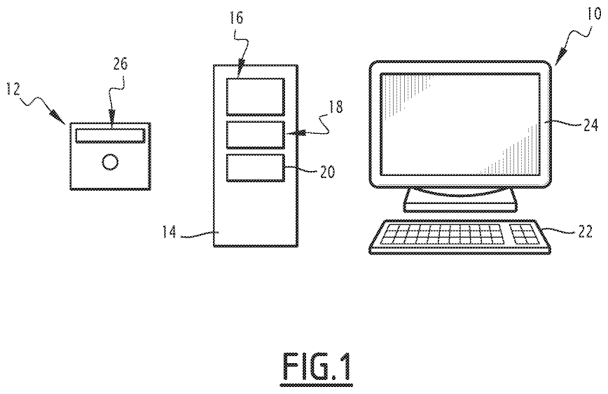

A calculator 10 and a computer program product 12 are illustrated on FIG. 1.

The calculator 10 is preferably a computer.

More generally, the controller 10 is a computer or computing system, or similar electronic computing device adapted to manipulate and/or transform data represented as physical, such as electronic, quantities within the computing system's registers and/or memories into other data similarly represented as physical quantities within the computing system's memories, registers or other such information storage, transmission or display devices.

The calculator 10 interacts with the computer program product 12.

As illustrated on FIG. 1, the calculator 10 comprises a processor 14 comprising a data processing unit 16, memories 18 and a reader 20 for information media. In the example illustrated on FIG. 1, the calculator 10 comprises a human machine interface 22, such as a keyboard, and a display 24.

The computer program product 12 comprises an information medium 26.

The information medium 26 is a medium readable by the calculator 10, usually by the data processing unit 16. The readable information medium 26 is a medium suitable for storing electronic instructions and capable of being coupled to a computer system bus.

By way of example, the information medium 26 is a USB key, a floppy disk or flexible disk (of the English name “Floppy disc”), an optical disk, a CD-ROM, a magneto-optical disk, a ROM memory, a memory RAM, EPROM memory, EEPROM memory, magnetic card or optical card.

On the information medium 26 is stored the computer program 12 comprising program instructions.

The computer program 12 is loadable on the data processing unit 16 and is adapted to entail the implementation of a method for predicting the time evolution of at least one parameter for a set of wells when the computer program 12 is loaded on the processing unit 16 of the calculator 10.

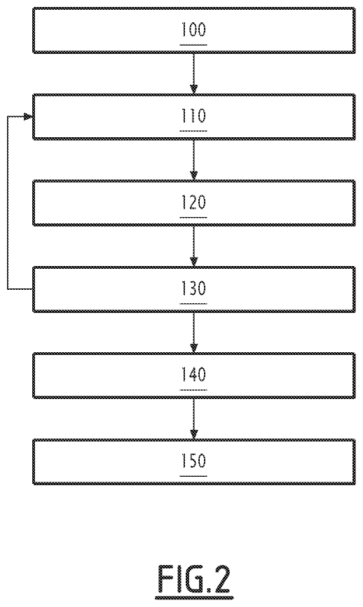

Operation of the calculator 10 will now be described with reference to FIG. 2, which diagrammatically illustrates an example of implementation of a method for predicting the time evolution of at least one parameter for a set of wells.

The set of wells are wells (also called drilling wells) belonging to one or several hydrocarbon fields. A field is an area where a large amount of hydrocarbons is buried and an attempt to extract it can be made by drilling wells. A field typically extends over several kilometers, allowing for several wells in one field.

The prediction method enables to predict the time evolution of at least one parameter for each well of the set. For example, the at least one parameter comprises at least one of the following parameters: the production of oil, the production of gas and the production of water.

At least some of the wells of the set are existing wells, which means that such wells are already in use and that a past evolution of the at least one parameter is available for said wells. In an embodiment, the set of wells comprises both existing wells and new wells. New wells are wells which are not in use or not yet existing and for which there is therefore no available past data relative to the at least one parameter.

The prediction method comprises a step 100 of obtaining input data relative to each well of the sets. The obtention step 100 is implemented by the calculator 10 in interaction with the computer program product 12, that is to say is implemented by a computer.

At least some input data of the wells comes for example from measurements carried out by one or several sensors.

The input data of at least the existing wells of the set comprises a past evolution of the at least one parameter for said wells. The past evolution is a temporal evolution of the at least one parameter over a past period of time.

Preferably, the input data of each well comprises data relative to the intrinsic properties of said well. The intrinsic properties are, for example, categorical data (field data, data relative to the field of the well, reservoir information . . . ), or numerical data (well location data, petrophysical data, well descriptive data (well length, . . . ).

The prediction method comprises a step 110 of selecting one or more prediction algorithms from a catalog (numerical catalog, also called database) comprising a plurality of prediction algorithms. The prediction algorithms are algorithms enabling to predict the time evolution of at least one parameter of a well. The selection step 110 is implemented by the calculator 10 in interaction with the computer program product 12, that is to say is implemented by a computer.

Preferably, the selected algorithms comprise at least one algorithm chosen among: an algorithm based on analytical equations and an algorithm based on machine learning (example regression algorithms, neural network, . . . ). Advantageously, the selected algorithms comprises both algorithms based on analytical equations and algorithms based on machine learning.

Some algorithms based on analytical equations are, for example, based on the Decline Curve Analysis (DCA) concept, in particular the Arps equations, and derivatives of the Arps equations. In another example, some algorithms are also based on regression methods (ensemble methods), such as the one described in WO 2019/199723.

Some algorithms based on machine learning are for example based on the training of a model on the basis of the past evolution data of the existing wells for the at least one parameter.

The catalog is, for example, regularly updated with new algorithms.

The selection of algorithm(s) is, for example, triggered by an operator via the human machine interface 22 of the calculator 10. For example, the algorithms are selected depending on the features of the field(s) comprising the wells of the set of wells. Such features are for example part of the input data.

Each prediction algorithm is associated with a conformity criterion. The conformity criterion of an algorithm is a criterion that must be fulfilled by the input data of a well so as to use the algorithm to build a prediction model for said well. The conformity criterion could also, for example, be modified or selected by the human operator.

For example, the conformity criterion of an algorithm based on analytical equations states that input data relative to the past time evolution of the at least one parameter is available for the considered well. Hence, if no past data is available for a well, as this the case for the new wells, the conformity criterion is not fulfilled. In another example, the conformity criterion is fulfilled if the modeled data by the prediction algorithm are close from the corresponding past time evolution (for example the deviation is inferior or equal to a predetermined threshold).

For example, each algorithm comprises one or more hyperparameters adjusting the behavior of the algorithm. The values of such hyperparameters are for example also adjusted during the selection step 110. For example, the values of the different hyperparameters are chosen by the operator (for example among a range of predefined values). The hyperparameters comprises, for example, one of the following hyperparameters among: a threshold indicating that the conformity criterion is fulfilled and an indicator stating that the algorithms is applied to other wells belonging to a same cluster or a same field.

Preferably, when several algorithms are selected from the catalog, each algorithm is also affected with an order of use. The order of use defines the order in which each selected algorithm is used to build a prediction algorithm for each well of the set. For example, the order of use of the algorithms is the order according to which the algorithms are selected.

The prediction method comprises a step 120 of building, for each well, a prediction model predicting the evolution of the at least one parameter for said well on the basis of the selected algorithm(s) and of the input data. The building step 120 is implemented by the calculator 10 in interaction with the computer program product 12, that is to say is implemented by a computer.

When several algorithms are selected from the catalog, the prediction model of each well is built with the first prediction algorithm for which the conformity criterion is fulfilled considering the order of use of the selected algorithms.

Preferably, the conformity criterion is such that, during the building step, prediction models for existing declining wells are obtained with algorithms based on analytical equations and prediction models for existing non-declining wells are obtained with algorithms based on machine learning.

The prediction method comprises a step 130 of validating the prediction models obtained for each well. The validation step 130 is implemented by the calculator 10 in interaction with the computer program product 12, that is to say is implemented by a computer.

In an example of implementation, to qualify the selected workflows (sequence of selected algorithms and associated hyperparameters), a blind test is performed where some production data is for example removed in order to test the output of the model and validate the selected sequence.

In this example, the validation step 130 comprises predicting, for each well of a subset of wells among the existing wells, the evolution on a past time period of the at least one parameter on the basis of the prediction model obtained for said well and of only some input data relative to said well by excluding the other input data relative to said well. In that case, the excluded data is preferably production data different from the production data used to select and built the prediction model. The excluded input data is for example the most recent past evolution of the at least one parameter on the past time period (also called blind test period). For example, for a past time evolution of several years, the excluded past time period is at least one year. The exclusion of data relative to a past time period enables to carry out a blind test for said data. For example, the subset of existing wells used during the validation step comprises at least 30% of the existing wells, or all the wells that where not subject of intervention during the blind test period.

At the end of the blind test, the prediction models of the wells are for example validated when a blind test criterion is fulfilled. The blind test criterion is validated when sufficient prediction algorithms are validated, for example 20% of the whole set, to apply ensemble methods for non declining wells. The prediction model of each well is for example validated when a consistency criterion is fulfilled. The consistency criterion states for example that the deviation between, the predicted cumulated values of the at least one parameter over the past time period and the cumulated values of the at least one parameter over the same past time period obtained with the input data, is inferior to a predetermined deviation, the predetermined deviation being for example inferior or equal to 20% during the relevant past period. When the consistency criterion is invalidated, the method is for example reiterate starting from the selecting step 110.

Preferably, when the set of wells contains new wells, the considered past time period for the validation step is the entire period of the input data corresponding to the past evolution of the at least one parameter. However, when the set of wells contains only existing wells, the considered past time period is typically strictly inferior to said entire period.

In another example, the validation step 130 comprises predicting, for each well of a subset of wells among the existing wells, the evolution on a past time period of the at least one parameter on the basis of the prediction model obtained for said well and of only some input data relative to said well by excluding the other input data relative to said well. In that case, the excluded data is preferably production data different from the production data used to select and built the prediction model. In another example, the excluded data were also used during at least one of the selection or building step.

In this example, the validation step 130 then comprises the comparison of the predicted evolution of the at least one parameter with the excluded input data on the basis of the consistency criterion. The prediction model is validated for a given well when the consistency criterion is fulfilled, and if not is invalidated. For the wells where the consistency criterion is invalidated, the method is for example reiterate starting from the selecting step 110. Preferably, the consistency criterion stipulates that a prediction model is validated when the deviation between, the predicted cumulated values of the at least one parameter over the past time period and the cumulated values of the at least one parameter over the same past time period obtained with the input data, is inferior to a predetermined deviation, the predetermined deviation being for example inferior or equal to 20% during the relevant past period.

The prediction method comprises a step 140 of predicting of the time evolution of the at least one parameter for at least one, advantageously each, well on the basis of the validated prediction model obtained for said well and of the input data of said well. The prediction step 140 is implemented by the calculator 10 in interaction with the computer program product 12, that is to say is implemented by a computer.

In an example, the prediction method comprises a step 150 of operating at least one well of the set of wells depending on the prediction obtained for said well. The operation consists for example of modifying a fluid extraction or setting a fluid extraction for the well.

Hence, the prediction method enables to predict in an efficient and replicable way the behavior of a wide range of wells. In particular, the step of selecting algorithms from a catalog enables to choose easily and efficiently prediction models adapted to a field of wells. In addition, the obtained models are more reliable and replicable because of the validation step.

In addition, the prediction method allows a prediction to both declining and non declining wells, for all fluids, which are often poorly taken into account in classical methods

The method also allows for the further development of potentially customized algorithms for certain fields, taking into account wells with established behavior (declining wells) but also less mature wells with less production history.

The person skilled in the art will understand that the embodiments and variants described above can be combined to form new embodiments provided that they are technically compatible.

In addition, in an example of implementation, the method is carried out for a first parameter among: the production of oil, the production of gas and the production of water, and is then carried out for at least another different parameter among: the production of oil, the production of gas and the production of water, and then advantageously for another parameter different from the first and the second parameters among: the production of oil, the production of gas and the production of water.

For example, the prediction obtained for the at least one parameter depends on the prediction obtained for another parameter (example: production of water determined as a function of the production of oil).

1. A method for predicting the time evolution of at least one parameter for a set of wells, the method comprising the following steps which are implemented by a computer:
obtaining input data relative to each well of the set, the input data of at least some wells, called existing wells, comprising a past evolution of the at least one parameter for said wells,
selecting one or more prediction algorithms from a catalog comprising a plurality of prediction algorithms, each prediction algorithm being associated with a conformity criterion, when several prediction algorithms are selected, each algorithm being affected with an order of use,
building, for each well, a prediction model predicting the evolution of the at least one parameter for said well on the basis of the selected algorithm(s) and of the input data, the prediction model of each well being built with the first prediction algorithm for which the conformity criterion is fulfilled considering the order of use of the selected algorithms,
validating the prediction models built for each well, and
prediction of the time evolution of the at least one parameter for at least one well on the basis of the validated prediction model obtained for said well and on the input data of said well.

2. The method according to claim 1, wherein the validation step comprises:
predicting, for each well of a subset of wells among the existing wells, the evolution on a past time period of the at least one parameter, on the basis of the prediction model obtained for said well and of only some input data relative to said well by excluding the other input data relative to said well, the excluded data being the past evolution of the at least one parameter on the past time period, and
comparing the predicted evolution of the at least one parameter with the excluded input data on the basis of a consistency criterion, the prediction model of said wells being validated when the consistency criterion is fulfilled.

3. The method according to claim 1, wherein the validation step comprises predicting, for each well of a subset of wells among the existing wells, the evolution on a past time period of the at least one parameter, on the basis of the prediction model obtained for said well and of only some input data relative to said well by excluding the other input data relative to said well, the excluded data being the past evolution of the at least one parameter on the past time period, the prediction models of the wells being validated when a blind test criterion is fulfilled, the blind test criterion stating that the prediction algorithm of each well is validated when a number of validated prediction models for the whole set of wells is above a predetermined threshold, the prediction model of each well being validated when a consistency criterion is fulfilled for said well.

4. The method according to claim 2, wherein the consistency criterion is validated when the deviation between, the predicted cumulated values of the at least one parameter over the past time period and the cumulated values of the at least one parameter over the same past time period obtained with the input data, is inferior to a predetermined deviation.

5. The method according to claim 1, wherein the catalog comprises at least two types of algorithms: one first type based on analytical equations and one second type based on machine learning.

6. The method according to claim 1, wherein the input data also comprises, for each well, data relative to the intrinsic properties of said well.

7. The method according to claim 1, wherein the set of wells comprises both existing wells and new wells, new wells being wells for which there is no available past data relative to the at least one parameter.

8. The method according to claim 7, wherein the validation step comprises predicting, for each well of a subset of wells among the existing wells, the evolution on a past time period of the at least one parameter, on the basis of the prediction model obtained for said well and of only some input data relative to said well by excluding the other input data relative to said well, the excluded data being the past evolution of the at least one parameter on the past time period, the prediction models of the wells being validated when a blind test criterion is fulfilled, the blind test criterion stating that the prediction algorithm of each well is validated when a number of validated prediction models for the whole set of wells is above a predetermined threshold, the prediction model of each well being validated when a consistency criterion is fulfilled for said well, and
wherein the considered past time period for the validation step is the entire period of the input data corresponding to the past evolution of the at least one parameter, which enables the validation or not of the prediction models of both existing wells and new wells.

9. The method according to claim 1, wherein the method comprises a step of operating at least one well of the set of wells depending on the prediction obtained for said well.

10. The method according to claim 1, wherein the at least one parameter comprises at least one of the following parameters: the production of oil, the production of gas and the production of water.

11. The method according to claim 10, wherein the method is carried out for a first parameter among: the production of oil, the production of gas and the production of water, and is then carried out for at least another different parameter among: the production of oil, the production of gas and the production of water.

12. The method according to claim 11, wherein the prediction obtained for the at least another parameter depends on the prediction obtained for the first parameter.

13. A computer program product comprising a readable information carrier having stored thereon a computer program comprising program instructions, the computer program being loadable onto a data processing unit and causing the method according to claim 1 to be carried out when the computer program is carried out on the data processing unit.

14. A readable information carrier on which a computer program product according to claim 13 is stored.

15. The method according to claim 5, wherein at least one algorithm of each type is selected during the selection step.

16. The method according to claim 6, wherein data relative to the intrinsic properties of the well are field data, reservoir information, well location data, petrochemical data or well length.
